(19) United States
(12) Patent Application Publication
(10) Pub. No.: US 2002/0138348 A1
(43) Pub. Date: Sep. 26, 2002

(54) Electronic coupon system

(76) Inventors: Sandhya Narayan, Palo Alto, CA (US); Shivaram Mysore, Palo Alto, CA (US)

Correspondence Address: Sandhya Narayan, 13998 Shadow Oaks Way, Saratoga, CA, 95070, US

(21) Appl. No.: 10/054,240

(22) Filed: Oct. 22, 2001

Related U.S. Application Data
(60) Provisional application No. 60/243,931, filed on Oct. 27, 2000.

(51) Int. Cl. G06F 17/60

(52) U.S. Cl. 705/14

(57) ABSTRACT

SV coupon system offers a new, unified and unique approach to make the coupon based incentive mechanism more effective and convenient for both online and in-store customers and issuers of coupons. In addition, it supports tracking of coupons through their lifecycle.

SV coupon system is not specific to any protocol and is based on standards like Extensible Markup Language (XML). It is a server-side solution, with no client-side changes, with customers being able to access their coupons from anywhere via the Internet or Point of Sale devices. Coupons issued by the Issuer can be stored by the consumer at a participating portal fore later redemption at a Retailer. The SV Trading System interacts with all the required parties to perform coupon-trading operations such as selling, buying or exchanging of coupons.

### 1 FEDERALLY SPONSORED RESEARCH

Not Applicable

### 2 SEQUENCE LISTING OR PROGRAM

Not Applicable

### 3 BACKGROUND OF INVENTION

1. Field of Invention

The Savings Value (SV) coupon system offers a new and unified approach to make incentive mechanism more effective and efficient for customers and issuers of coupons.

2. State of the Art

A coupon is basically a certificate entitling the bearer to a discount, refund or gift. Coupons on the Internet are currently modeled after print media. In the system described here called the SavingsValue (SV) coupon system, the customer could store a digital coupon and retrieve it a later time for online or off-line use. Optionally he could also trade the coupon.

If each individual application uses a different issuing or collecting system to handle loyalty points or coupons, the implementation cost will be too high, especially for small businesses. Consumers may also be forced to install a number of software modules to handle these points or coupons. Such a system is hence unattractive.

The SV coupon system enables companies, individuals or other entities to freely issue, transfer, trade and redeem various types of coupons electronically (e.g., via the Internet). It does not require customers to install any additional software on their systems. A wide-range of electronic-values including loyalty points or coupons can be handled in a uniform manner using this software system.

Depending on the mode of delivery, two kinds of coupons are common: printed coupons delivered via newspapers and other forms of print media, and E-coupons delivered via the Internet, which may be in the form of email or banner advertisements at online retail or portal sites, or even at sites which explicitly serve coupons.

Traditional printed coupons are inconvenient to consumers. They need to be cut, saved and then presented at a retailer for redemption. Often, people forget to use the coupons, or the coupons may expire before they are actually needed. Further, in the case of mail-in rebates, there is often a huge delay in redemption as it takes 6 to 8 weeks with no way of knowing what is happening. Added to this is the expense of mailing the coupon, along with the proof of purchase. These factors discourage many customers from using coupons.

Online couponing is still in its early stages. Currently, there is no good way of storing, retrieving, and bartering of coupons for an online purchaser. Also, for a manufacturer or a merchant there is no good way of presenting and accepting coupons to and from the customer. All the current models use custom solutions, ad hoc in most cases and are modeled from the existing old-style coupon schemes. A problem with existing digital systems is that copying is very easy and cheap, and is not very easy to detect if some checks in the system are not present. For example, in some cases the coupon may have an identifier called an E-Value code, which needs to be entered while making an online purchase. Anyone who knows the E-Value code could use it without even looking at the coupon.

In all of these cases, there is no way of tracking who saw the coupon first or its life cycle from generation to redemption, which is necessary for manufacturers to better understand customer behavior and provide product positioning.

For customers SV Coupon System provides an easy way to store, retrieve, manage, barter and redeem coupons. For the Merchant or Manufacturer this provides simple and uniform mechanism to value, verify, present and redeem coupons. It offers an efficient way of utilizing the product promotional dollars and improving brand recognition.

SV coupon system is not specific to any protocol, programming language/tool, or electronic environment. In one embodiment, however, it is based on standards like Extensible Markup Language (XML). This embodiment is a server-side solution, with no client-side changes, thus allowing customers to access their coupons even from Point of Sale devices. This solution has been modeled after real life scenarios wherein Manufacturers and Retailers can be Issuers, a Consumer or Portal is a Holder, and another (or the same) Manufacturer or Retailer who acts as the Collector. Also, a present embodiment of the invention includes a Trading system that interacts with all the required parties to perform trading operations.

### Requirements for Digital-Right Trading

An Internet Draft Requirements document for Digital-Right Trading is available at http://www.ietf.org/internet-drafts/draft-ietf-trade-drt-reqements-00.txt. This proposal requires consumers to install software modules. It is specific to IOTP (Internet Open Trading Protocol). It describes the requirements for such a Digital Right. No implementation or complete solution is provided. Also, there is no concept of Trading.

As of February of 2001, a version of 2 of the requirements is available at http://www.ietf.org/internet-drafts/draft-ietf-trade-drt-requirements-02.txt that does talk about trading of “Vouchers” (formerly Digital Rights). But, this trading can happen only between two wallets of the same or similar kind. Of course, you will have to know the other party if this transaction can occur. A side effect of this is that the tracking of the coupon flow is cut-off, even if such a system were to incorporate this.

### 4 SUMMARY OF THE INVENTION

Advertising is like an engine of a train. It drives sales. Coupons help advertising by keeping customers in a continuous process. The SV Coupon system provides manufacturers and retailers a mechanism to easily issue, track and redeem coupons. This also provides customers with easy coupon management software, readily accessible from anywhere with privacy and increases savings. To facilitate this interaction between the customer and the merchant, the portal plays a very important role in providing value-added services. The system may be configured to operate similar to traditional coupon systems currently in place in the off-line world, while using new, emerging and as-yet unknown technologies.

### 5 DRAWINGS

### Brief Listing of Drawing Figures

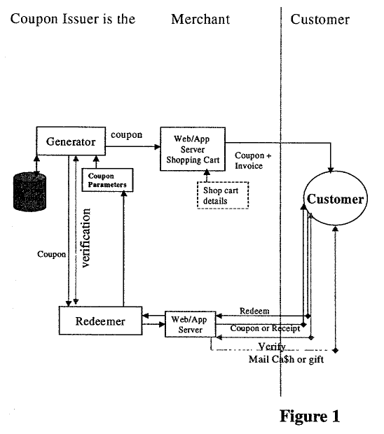

FIG. 1: Block Diagram showing the basic SV online coupon system.

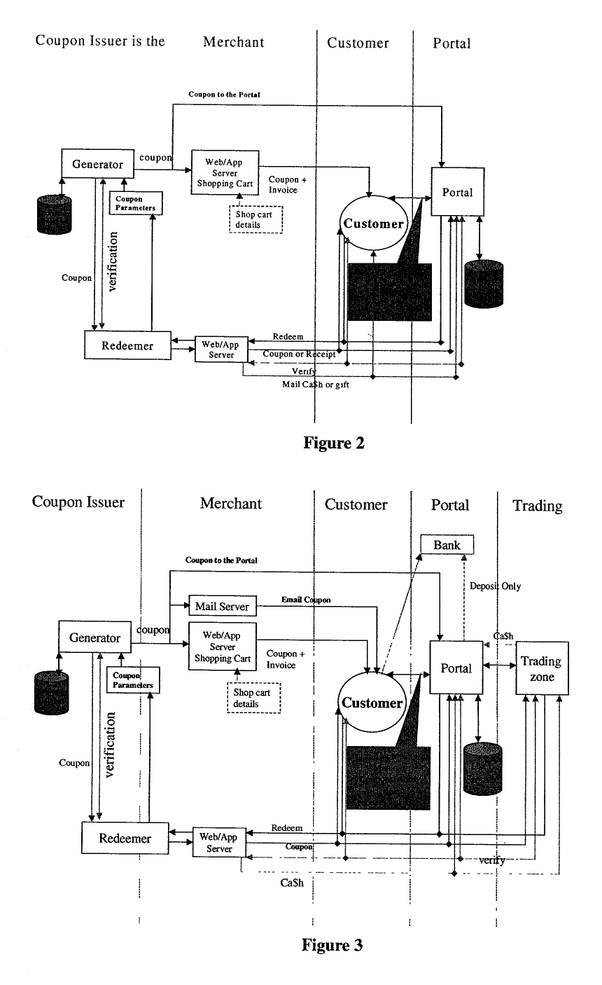

FIG. 2: Block Diagram of the SV coupon system enhanced with portal storage.

FIG. 3: Block Diagram of the SV online coupon system enhanced with portal storage and trading zone.

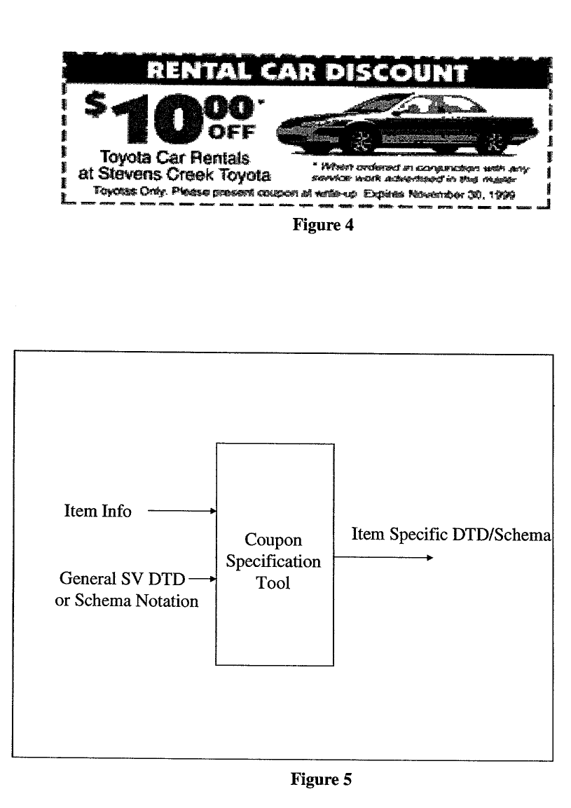

FIG. 4: Sample coupon

FIG. 5: Coupon specification

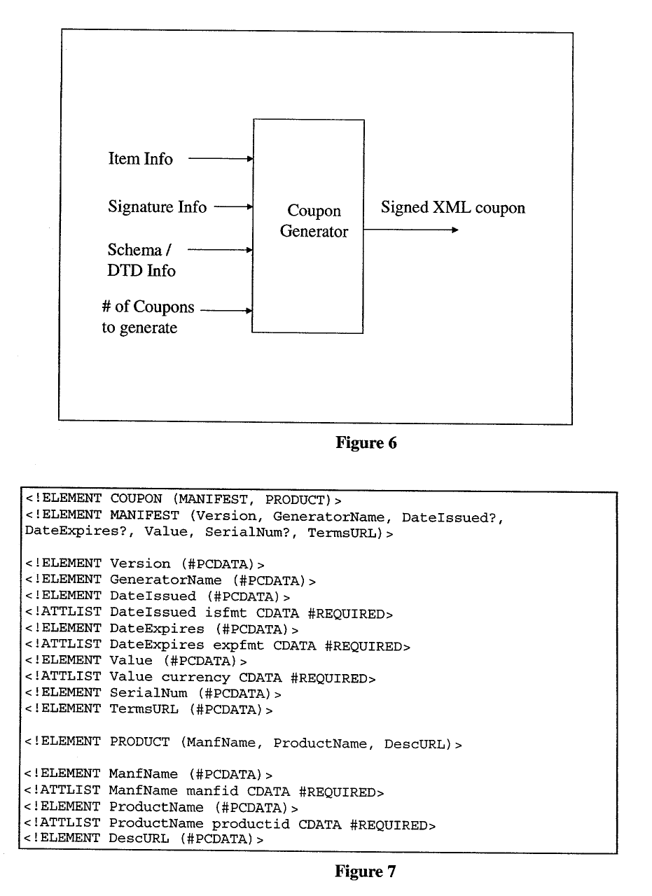

FIG. 6: Coupon generation

FIG. 7: A Sample Savings Value Generator DTD

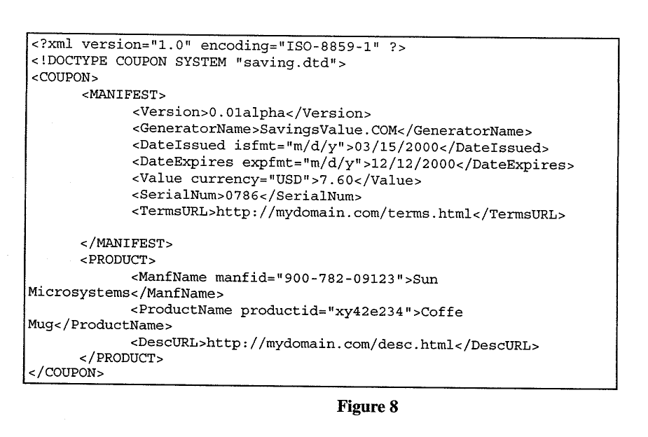

FIG. 8: An Unsigned Coupon using a pre-defined DTD

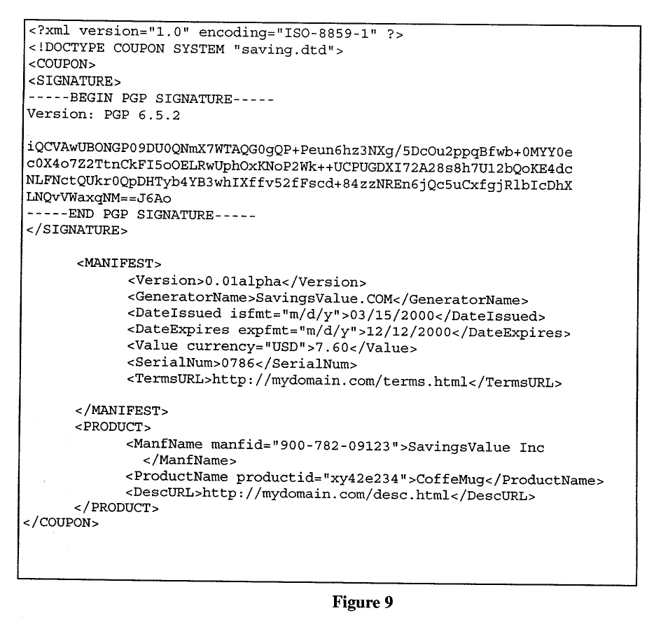

FIG. 9: A PGP Signed XML Coupon

FIG. 9A: A Signed XML Coupon using XML Schema

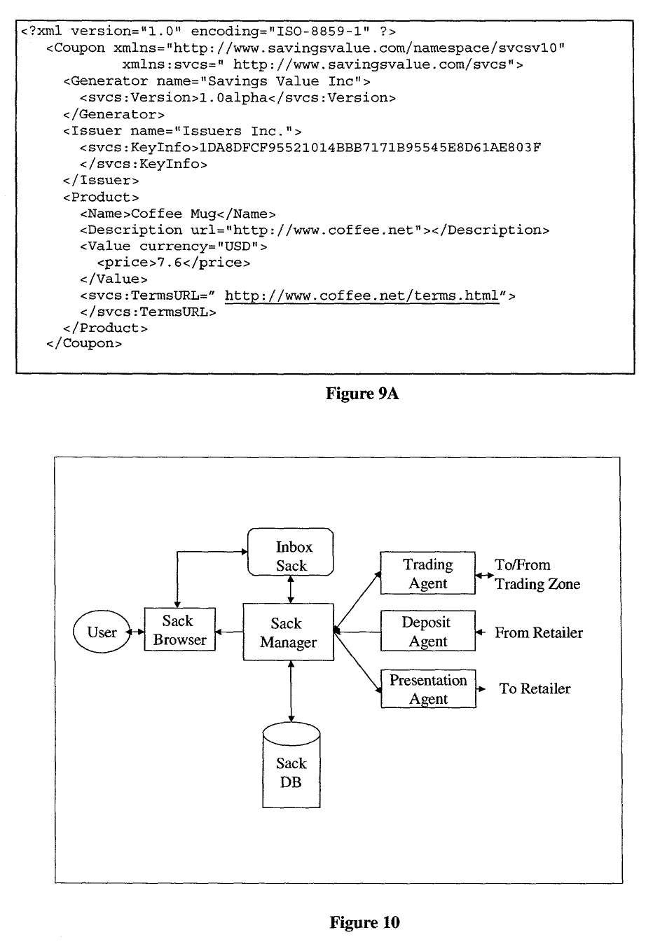

FIG. 10: Block Diagram of the SV portal coupon storage system

### 6 DETAILED DESCRIPTION OF PREFERRED EMBODIMENT

In an electronic marketplace (e.g., such as the Internet), time and convenience are of the essence. In one embodiment of the invention, coupons are distributed via email, web sites and/or other electronic forms of communication. For example, in other embodiments coupons may be accessed through Personal Digital Assistants or cellular phones and then transferred to online storage. Illustratively, however, the coupons provided for in present embodiments of the invention may be used for online and/or off-line purchases.

The SV coupon system in a present embodiment provides:

1. Easy coupon storage, management and barter systems for the customer.

2. Easy generation, tracking and redeeming systems for the Merchant and Manufacturer.

3. Ability to track a coupon's lifecycle using the process of digitally signing the coupon at every stage as it moves from the manufacturer to the retailer then to the customer.

The above capabilities enable:

1. Savings to the consumer.

2. Better utilization of advertising dollars.

3. Increased influence in product sales for Merchant and Manufacturer.

4. Increased exposure for the Manufacturer and the Retailer.

The SV coupon system in a present embodiment involves the following major entities:

Manufacturer

Merchant

Consumer

Coupon portal

Trading zone

FIG. 1, FIG. 2 and FIG. 3 show models of the system starting from a basic model and increasing in features and value.

FIG. 1 depicts an overall view of the interaction between the various entities involved in the basic SV coupon system for one embodiment of the invention. The manufacturer produces coupons and distributes them to consumers. A redeemer (e.g., a retailer) assists in the distribution and redemption of the coupons via interaction with the consumers. One key feature of this basic system is the uniform and secure handling of coupons during their lifecycle.

FIG. 2 shows a block diagram of an SV coupon system enhanced with portal storage capability, according to another embodiment of the invention. This embodiment enables coupons to be stored, managed and accessed seamlessly at participating coupon-redeeming locations. The portal provides secure bins to member-consumers for storing their coupons, tools for managing the stored coupons, and mechanisms for easy presentation at retailers. As they are stored online, the coupons can be accessed from anywhere and at anytime.

FIG. 3 shows a block diagram of an SV coupon system enhanced with the portal storage and a trading zone, according to yet another embodiment of the invention. This embodiment enables coupons to be traded (i.e. exchanged, bartered, sold or given to charity) between participants, to the benefit of both trading parties.

The following section describes the actions and interactions among the five main entities of the SV coupon system. However, present embodiments of the invention need not include all five entities, nor are they limited to these entities.

### 6.1 Major Entities

This section describes illustrative aspects, roles, functions, etc., of entities that may be included in an embodiment of the invention. The interaction between the various entities may differ to a large or small degree in different embodiments.

### 6.1.1 Manufacturer

A manufacturer is a producer of products and/or services. In the context of promotion of these products the manufacturer's primary goals may include:

1. Increase revenue and profitability.

2. Advertise wisely.

3. Build brand name.

4. Get new customers.

5. Deploy tracking mechanism for products and customers to better target the product.

SV Solution:

A simple and easy to use system encourages customers to use coupons, thereby building loyalty and increasing sales. This also brings in new customers, who want to take advantage of the features offered by the system. In addition, the trading facility provided by the SV coupon system enables secondary promotion through bartering. The system increases the visibility of coupons by displaying them many times. For example, when issued, when redeemed, when browsing through one's personal coupon storage bin, at the time of flagging events such as expiration time, during trading interactions, etc., the consumer is shown a coupon again and again, hence promoting more awareness of the product. In addition, as the coupon is digitally signed, it is easy to track and validate.

### 6.1.2 Retailer [Merchant]

A Retailer or Merchant is the primary interface for reselling a manufacturer's product and services and also serves as a coupon distributor and redeemer. Major goals of a Retailer with respect to coupon promotions may include:

1. Distribute Manufacturer's Coupons.

2. Redeem Manufacturer coupons and collect handling charges from the same.

3. Provide the Retailer's own set of coupons for different products sold from the store, and also redeem them.

SV Solution:

The retailer acquires coupons produced by the manufacturer either in bulk or on demand. The retailer (or another entity) distributes these coupons to the consumer, possibly as part of a sales transaction or when the consumer browses through the store. The retailer also facilitates redemption of coupons during a sales transaction. For this purpose the retailer may interact with the coupon tracking and verification system and the coupon redemption system of the manufacturer or coupon issuer.

### 6.1.3 Consumer

A Consumer uses a coupon provided by the manufacturer or a retailer. A consumer's goals/desires with respect to coupons may include:

1. Easily store the coupon.

2. Ability to store a digital coupon obtained from an off-line retailer in an online portal place.

3. Ability to electronically access the stored coupon from virtually any electronic site, such as with a Redeemer.

4. Ability to trade the coupon just like in the real (offline) world.

5. Ability to auction the coupon.

6. Redeem a coupon for its value.

7. If redeeming for cash, as with mail-in rebates, the money should be deposited directly in an appropriate account of the consumer.

8. If redeeming for goods (e.g., sent by mail), minimizing the need to repeatedly provide address or other information.

9. Protect privacy of transactions.

SV Solution:

The consumer benefits greatly from the SV coupon system as it enables him to extract great value from coupons with very little effort. A consumer is only a mouse click away from the savings offered by a coupon. At his portal of choice, the saved coupons are easily organized, automatically checked for expiration and readily made available for trade. Redeeming is also made easy, because the consumer automatically carries (figuratively) a coupon-sack when he enters an online store. Illustratively, a sack is a virtual collection of coupons. The redeemed value is adjusted during the consumer's transaction.

The consumer may personalize his preferences, such as shipping address, billing address, bank account information, etc., at a portal. This information may be used in automatically filling the forms that need to be submitted to the redeemer for coupon redemption. A consumer's privacy may be protected to various degrees, depending on the consumer's requests and/or the needs of other entities in the system. For example, bank account information may not be released to the redeemer.

In case of redemption for cash, the redeemer may deposit the money to the consumer's portal and the portal then deposits it in the consumer's bank or other account. In this way, the redeemer will only know that a consumer from this place redeemed the coupon, but not know where his bank accounts are. This type of transaction prohibits misuse of information and is just one example of how a consumer's privacy may be protected.

In the case of redemption for goods, the redeemer may package the goods to be shipped and tag it with a unique ID. This ID is sent to the portal that sent in the request for the consumer, and may also be sent to the shipper. The portal then sends the address to the shipper with the associated ID to deliver the goods to the consumer.

### 6.1.4 Portal

A Portal may be an electronic (e.g., Internet) site acting as a gateway to the online world. It provides its patrons with a number of features in order to retain them and increase the use of its site. Goals or characteristics of a portal may include:

Attract new visitors—eyeball traffic and retain current users.

Create multiple reasons for its users to use their services.

Main revenue stream may be advertising.

Another lucrative revenue stream may be sales occurring as a result of advertising.

Provide a unified and easy way for a customer or user to perform most of his or her activities.

Enable privacy for its users.

Provide a trading environment to trade coupons.

SV Solution:

In the SV coupon system, portals may provide coupon storage and management features to their members. Portals bring in consumers to use coupon system. But, as consumers realize the value of the coupon system, they may visit the portal more often and stay longer. Portals may also provide customization by providing space that is configurable by the consumers, provide unique login Ids, and other features. They may also store sacred data from the customers by providing security around their system software.

Through a portal, Consumers may be provided with a trading environment, where they can mark coupons for trade and list what they would accept in return. When a coupon is placed for trade it may be the portal's responsibility to validate the parameters before placing the coupon in the trading zone. The trading zone environment is explained in more detail in the next section.

### 6.1.5 Trading Zone

A Trading Zone is a place where auction, sale, bartering and/or other coupon activities may take place. It may be somewhat similar to a trading system wherein different stocks are traded (e.g., NASDAQ). Its goals/characteristics may include the following:

1. Enable bartering of coupons.

2. Enable coupon trades: 1 for 1, 1 for many, many for 1, etc.

3. Auction coupons and deposit the proceeds into the user's account.

4. Automatically execute trades based on specified rules.

SV Solution:

The trading zone brings together all the consumers into one marketplace for trading coupons. Different mechanisms of trade may be supported, such as simple barter, multi-party barter, auctions, fixed price sales etc.

### 6.2 Functional Description

This section describes illustrative functions performed by the various components of the SV coupon system according to a present embodiment of the invention. Additional or fewer functions may be included in other embodiments.

### 6.2.1 Design Philosophy

A coupon may contain required and/or optional items. Some required items may include: issuer name, value, expiration data, associated product set. Some optional items may include: serial number, bar code, merchant terms and conditions, consumer terms and conditions, cash value, etc. An example of a physical coupon is shown in FIG. 4.

### Use of XML

XML (Extensible Markup Language) is a standardized development language that is well suited to facilitate the integration of legacy infrastructures in an electronic environment. XML based architectures also provide a cost-effective way to do better business as well as lower the cost of exploiting new business opportunities.

In a present embodiment of the invention, XML is used to describe data as well as structure it so that it can be effectively processed wherever it is received. Because XML helps separate data from presentation, a client can- get different views of the data without returning to a server. XML markup reflects the meaning of information, making it possible for any user, or application, to derive precisely what it needs to see and operate on it, perhaps integrating it with other information it has already received. This is a useful improvement over the typical HTML (Hyper Text Markup Language) publisher-client relationship.

Today's web servers only deliver presentation content to browsers. Using XML enables the SV system to serve data together with its structure and meaning. The data is therefore more readily accessible and can be used by many applications throughout the enterprise.

Because of the separation between data and presentation, XML documents can be signed. Signing XML documents allows for verification of the content. One further step in this direction is encryption of sacred data in the document, such as a credit card number. XML document signing, encrypting, key/trust management, and other security services are based on standards.

### Illustrative Characteristics of an XML-Based Embodiment of an SV Coupon System:

Coupons are in the form of XML documents, with uniform methods to handle them.

Less storage space is required.

All of the XML documents are signed. Therefore they can be easily verified and tracked.

Optionally, sacred data like credit card numbers, etc., could be encrypted without encrypting the whole document, thus enabling faster processing

### 6.2.2 Generator

A Generator is a mechanism providing uniform and secure XML based coupon by accepting a set of input parameters and a DTD (Document Type Definition) or XML Schema that is now becoming a standard.

An XML DTD is created for a generic coupon. Derivatives of this DTD can be created for various vertical markets. Coupons can be generated as and when needed. The generator gathers and keeps complete details about the set of coupons it has to produce, tracks the number of each kind issued, and can present reports. This is achieved using a tracking database.

To generate a coupon, the following information may be used:

1. Item specific data.

2. Corresponding DTD or Schema notation.

3. Signature information.

4. Number of coupons to generate.

Item specific information taken from the manufacturer's database may be transformed using a corresponding DTD (FIG. 7) to create an unsigned XML coupon (FIG. 7). The coupon specification tool (FIG. 5) allows a manufacturer to specify characteristics for a coupon such as validity, item name, SKU number, discount value etc.

The coupon-generating tool (FIG. 6) gets a request to issue a specific type of coupon and outputs the needed coupon, with its serial number, date, etc. The number of coupons generated depends on the input request for number of coupons. The coupons can be generated in bulk and stored, or they can be generated dynamically as and when needed. Using the signature information provided, the coupon is digitally signed to generate a signed XML coupon (FIG. 9, FIG. 9A).

### 6.2.3 Coupon Distribution Component of Online-Retailer

Retailers and Merchants accomplish the task of coupon distribution in a variety of ways. Illustratively, they may:

Place coupons in the form of banner ads on web sites.

Give coupons to customers who satisfy certain criteria, such as buying X dollars worth of goods, every 100^{th} customer, etc.

Email coupons to selected customers.

In the case of coupons accessed through on-line banner ads, pop-ups, or other comparable methods, the customer can click on the coupon (having the form of an advertisement) and save it. Illustratively, the coupon is saved at the customer's preselected portal. For distribution of coupons via email, a number of commercial email server software packages are available. Coupons may be sent as attachments in the email. Coupons could be issued on rule-based logic embedded into the on-line retailers software depending on their needs.

### 6.2.4 Coupon Tracking and Verification

During coupon generation, coupon-tracking information such as coupon serial number, details of coupon-issue, date, time etc. may be stored in a coupon-tracking database. This may be done for verification and/or redeeming purposes. As a part of Verification, signature information is checked on the signed XML coupon.

If a retailer is distributing a manufacturer's coupon, the retailer could have a similar tracking database for the coupons it distributes. This kind of tracking may be necessary for collecting handling charges from manufacturers or to track coupons issued.

### 6.2.5 Redeemer and Coupon Collection Component of Online-Retailer

This is where the retailer comes to know how his coupon paid off. The higher the number of coupons retailed, the more sales that may have happened, which could translate into more revenue.

When a coupon is presented to a retailer, it could be for some of the following reasons:

Redemption for savings on an invoice.

Redemption for another set of coupon(s).

Redemption for cash.

Redemption for non-cash value goods.

The retailer's coupon collection component may do a series of checks in order to complete a transaction request. It may, for example:

Check validity of the coupon (content, time, acceptability, etc).

Initiate a transaction with the coupon issuer to verify the coupon and inform it about redemption terms and conditions.

Get response back from the issuer and store result.

Depending on the response, the coupon may be acted upon and the coupon presented to the merchant may be provided a receipt for the transaction.

The retailer may then initiate other actions as necessitated.

The retailer may collect handling charges from the issuer. The issuer may allow redemption of its coupons by authorized agents or retailers.

Also a Redeemer could be a retail merchant or a manufacturer. Whoever first issues (generates) the coupon becomes the ultimate redeemer. In many cases, the customer knows only the retailer and never knows about the distributor or the manufacturer. If a manufacturer coupon is presented at the retailer, the retailer redeems it for the consumer and then presents it to the manufacturer directly or indirectly (via a distributor) to collect its charges for handling such a transaction.

### 6.2.6 SV Portal Coupon Storage System

The SV portal coupon storage system enables members to securely store and manage online coupons in personal bins (called Sacks), which are allocated for their use at a participating portal. Thus, a portal may provide storage and bin management functions to its clients, who are members of the SV coupon system.

When a consumer acquires an online coupon, he or she can store it in their Sack at their portal of choice. They can manage the set of coupons in their Sack, keeping what they want and deleting others. During a shopping session at participating online stores, the Sack can be examined to see if any of the stored coupons can be used at that site. The system also manages the expiration time, deleting any expired coupons automatically.

Illustrative capabilities of a SV portal coupon storage system are listed below:

1. Authenticate and login the member.

2. Provide a temporary storage for coupons.

3. Collect a coupon and store it in an Inbox of a Sack.

4. Present a coupon to a merchant during purchase for redemption.

5. Present a coupon to the trading system for coupon trading.

6. Provide Sack management functions such as:

a. Move coupons form Inbox to Sack.

b. Delete coupons in Inbox or Sack.

c. Personalize the Sack for coupon invitations, types of redemption, etc.

d. Cancel a placed trading transaction.

e. Place a coupon for transfer to another member.

f. Place a coupon for trade.

g. Print on-line coupons for off-line usage.

7. Manage Expiration time. This enables automatic deletion of coupons upon expiry.

8. Notify that certain coupons will expire in the next X hours/days.

A block diagram of an SV portal coupon storage system according to one embodiment of the invention is shown in FIG. 2 and FIG. 3. It comprises the following components:

Sack manager and personalizer.

Sack browser.

Coupon deposit agent.

Coupon presentation agent.

Coupon trading agent.

The Sack Manager (see FIG. 10) is responsible for executing a user's sack management functions, such as storing, deleting, etc. It also handles all notifications to the user.

The Personalizer component focuses on getting and managing user preferences such as bank account information for direct deposits and trading, shipping addresses, notification requests, direct coupon requests, etc.

The Sack Browser is designed for user interaction with his Sack. It provides easy browsing, searching, and management capabilities. This is a page where a user may be expected to spend some time, and therefore may be a good candidate for advertising.

The coupon deposit agent handles interaction with a coupon issuer and deposits a coupon into the user's coupon Inbox. Coupons could be obtained and deposited in the following ways:

When a member shops at a participating retailer, the retailer can issue a coupon to him, which gets directly deposited into the member's Inbox.

Participating retailers can issue coupons directly if they have the member's permission.

Members can transfer coupons to other members. The transfer agent makes the coupon available to the deposit agent, which puts it in the Inbox of the recipient member.

Members can trade coupons. The trading agent makes the coupon available to the deposit agent, which puts it in the Inbox of the recipient member.

The coupon presentation agent presents the coupon to the redeeming agent component of the retailer accepting coupons for redemption. When the redemption request is verified and the coupon is accepted, the coupon is removed from the user's Sack.

The coupon-trading agent gathers the trading options selected by the user and handles the interactions with the trading zone during the course of the trade. It is the trading agent's responsibility to transfer the coupon from one of the many folders in the sack to the trading folder.

### 6.2.7 Trading Zone

The coupon trading system enables members to exchange, barter, sell, or gift coupons to other members. The system handles communicating with all parties involved in the trade and execution of that trade.

### 6.2.7.1 Trade Setup

Let us consider an example where the user wants to sell a coupon. Some of the actions the user may take include:

He logs on to his portal.

He selects option to sell coupon for cash.

He selects the coupon to sell from his coupon sack.

He sets properties on the coupon for sale, such as price wanted, “good-for” period, and other terms.

The user may have already set any preferences for notification of the status of any transaction (e.g., when he signed up for the service).

In the case of buying coupons, the customer may be required to have a balance in his account equal to or more than the transaction cost in order to start the transaction. The portal checks his account status for the necessary amount. If the account has sufficient funds, the amount required is locked and the transaction is started with the Trading zone. The Trading zone assumes that the portal is responsible if there is an error in this transaction. The rest of the customer's actions are similar to the case of selling a coupon.

### 6.2.7.2 Trading Options

In a present embodiment, a user may select one of the following trading transactions:

1. Online Store - Fixed Price Sale (Cash buy/sell)

2. Auction (Cash buy/sell)

3. Barter: sell Coupon X for Coupon Y. Illustrative barter options may include:

a. Simple or two-party Barter

b. Multi-party barter

### Online Store—Fixed Price Sale (Cash Buy/Sell)

In this case the user has selected to use the online store mode and sets a sale price for his coupon. The coupon gets listed in the coupon store according to its category. Another user browsing through the categories or via a coupon search operation can find it. The trading zone guides the user to place his order, collects the sale amount from the user's account, and deposits it in the original owner's account, taking any sales commission as specified. It then transfers the coupon to the buyer's Inbox at his portal.

### Auction (Cash Buy/Sell)

In this case the user has selected to use the auction mode and sets a minimum auction price for his coupon. The coupon gets listed in the coupon auction store according to its category. Another user browsing through the categories or via a coupon search operation can find it. The trading zone guides the user to make bids. Once the auction is complete, the rest of the transaction is done as in the case of fixed price sale.

### Barter—Sell Coupon X for Coupon Y

In this embodiment there are 2 cases: Simple (or two-party) barter and Multi-party barter.

Simple Barter: User A and user B agree to barter coupons.

A_{(Buy X, Sell Y)} [symbol] B_{(Buy Y, Sell X)}

Multi-party Barter: User A, user B and user C together can exchange coupons so that they all get what they want.

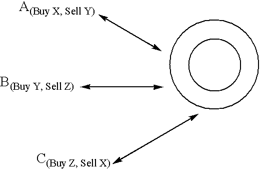

The trading agent automatically executes these exchanges. No user interaction is involved once a coupon is placed for barter transaction.

We claim:

1. Method of providing an Electronic Coupon System comprising:

2. Coupon generation, Coupon distribution, Coupon Storage, Coupon Storage Management, Coupon Verification, Coupon Redemption for cash, value or coupon and Coupon Trading.

3. The method of claim 2, wherein the coupon generated is uniform, digital and secure XML based for online and offline use.

4. The method of claim 3, wherein the coupon generated is by accepting a set of input parameters.

5. The method of claim 4, wherein the generated coupons could be in bulk or on-demand.

6. The method of claim 3, wherein the generated coupons are tracked using a Tracking Database for later use in trading, verification and redemption.

7. The method of claim 6, wherein the tracking database is a database of coupon parameters and coupon state.

8. The method of claim 2, wherein the distributing mechanism enables distribution of generated coupons from a Internet Web site in a variety of forms including, but not limited to banner ads, hyperlinks, pictures, text, archived sets, e-mail, Or from Point of Sale Terminals at a store, Or from any other electronic protocol or mechanism.

9. The method of claim 8, wherein the distribution mechanism may also include a coupon Tracking database.

10. The method of claim 9, wherein the tracking database is a database of coupon parameters and coupon state.

11. The method of claim 2, wherein the coupon storage system enables customer members to securely store online coupons in personal bins (called Sacks), which are allocated for their use at a participating portal.

12. The method of claim 11, wherein the coupon storage system also provides management functions including, but not limited to deleting expired coupons automatically, personalizing the Sack for trading, receiving and storing coupons.

13. The method of claim 2, wherein the coupon trading system enables members to exchange, barter, sell, or gift coupons to other members.

14. The method of claim 13, wherein the coupon trading system enables members to set policies for automatic trading transactions.

15. The method of claim 2, wherein the coupon verification system provides mechanism for verification of coupons.

16. The method of claim 2, wherein the coupon redemption system provides mechanism for redeeming coupons by coupon issuer and redeeming outlets for value associated with the presented coupon.

17. The method of claim 16, wherein the coupon redemption system provides mechanism for redeeming coupons with automatic deposit of redeemed cash values into user's bank account.

18. The method of claim 17, wherein the redemption system is preceded by enabling Coupon Verification.

19. The method of a Coupon Trading system, wherein electronic coupons can be bought, sold or exchanged for value by parties.

20. The Method of claim 19, wherein the parties could the buyer, seller or the trading arbiter.

21. The method of claim 19, wherein the value could be cash, kind (goods), or coupons of value depending on the terms agreed to by the parties.

22. The method of digitally signing the coupons by each of the party involved when it passes from one entity to another.
